(19) United States
(12) Patent Application Publication
(10) Pub. No.: US 2003/0214942 A1
(43) Pub. Date: Nov. 20, 2003

(54) Web-based computer telephony integration and automatic call distribution

(76) Inventors: Mohammed Zamshed Ali, Plano, TX (US); Abed Wahid Chowdhury, Plano, TX (US)

Correspondence Address: Steven Thrasher, 391 Sandhill Dr., Richardson, TX, 75080, US

(21) Appl. No.: 10/439,092

(22) Filed: May 15, 2003

Related U.S. Application Data
(60) Provisional application No. 60/380,470, filed on May 15, 2002.

(51) Int. Cl. H04L 12/66

(52) U.S. Cl. 370/352

(57) ABSTRACT

The invention is a system and method that provides a call center solution. The system includes, on a single network, a voice server and an internet-enabled web server (the web server). The web server performs computer telephony integration (CTI) server operations and automatic call distributor (ACD) operations. The method of implementing a call center solution carries a message to a customer service center by using a voice server module and a web server module.

### CROSS-REFERENCE TO RELATED APPLICATION

The invention is related to and claims priority from U.S. Provisional Patent Application No. 60/380,470, entitled Computer Telephony Integration Utilizing Conventional Web Technology to Chowdhury, et al. that was filed on May 15, 2002, which is incorporated by reference herein.

### TECHNICAL FIELD

The invention relates to telecommunications, and, more particularly, the invention relates to web-based telephony.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Small and medium sized businesses face complex and difficult communication system challenges. For example, businesses, no matter how small, need access to telephone lines, and, increasingly, to data-communication lines. However, systems that provide conventional technology at an affordable price (such as residential telephone lines) often lack performance characteristics needed by businesses—such as multiple line service and support. Similarly, systems that provide needed options are often expensive.

For example, in a call center application, such as a customer relations management (CRM) application, a computer telephony integration (CTI) server is used in conjunction with an Automatic Call Distributor (ACD) switch to transfer a call to various “on premises” equipment. In operation, this means that if a message (meaning the call and any associated data) needs to be transferred to a customer service center or an agent terminal (such as a manual terminator operator console (MTOC)) then the message must be routed from an interactive voice responsive unit (IVR) to both a CTI server and an ACD simultaneously.

This means that the customer service center must purchase an IVR, a hardware based CTI, and a hardware-based ACD—which are each very expensive pieces of hardware equipment. Present computer telephony networks use two distinct networks—one for data and the other for voice, and employ client-server based technology. In addition to technological disadvantages, present computer telephony networks require that call center agents be in a closed network environment (such as an Intranet). Accordingly, providing full customer service is often cost prohibitive for a small or medium sized business. Accordingly, there is a need for a cost-effective solution that provides complex voice and data functionality to a user such as a small business. The invention teaches such systems, devices, and methods.

Selected Overview of Selected Embodiments

The invention provides technical advantages as a system and method that provides a call center solution. The system includes, on a single network, a voice server and an internet-enabled web server (the web server) that are enabled together to provide voice and data to an agent terminal by using Voice over Internet Protocol technology. The web server performs computer telephony integration (CTI) server operations, and automatic call distributor (ACD) operations.

One method of implementing a call center solution carries a message to a customer service center by using a voice server module and a web server module. The voice server module generally captures a user input data and passes it to the web server module, preferably by using Voice over Internet Protocol. The web server module identifies the proper platform for running a web browser, pushes data to the web browser, and notifies an agent that the data is viewable on the browser.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows one embodiment of a web-enabled computer telephony system;

FIG. 2 illustrates one method of operation of a computer telephony system based on a web server telephony server according to the invention; and

FIG. 3 teaches one method of operation of a web server/telephony server in a computer telephony system.

### AN EXEMPLARY EMBODIMENT OF A BEST MODE

Interpretation Considerations

The invention can be characterized as systems and methods that provides a call center solution. This uses a single network to provide a voice server and an internet-enabled web server (the web server). The web server performs computer telephony integration (CTI) server operations and automatic call distributor (ACD) operations. One method of implementing a call center solution carries a message to a customer service center modularly.

This allows agents to be located remote from the network, yet integrate with the network in a way that is apparently seamless to an end-user. Accordingly, by using a server only for data communication, the invention provides an internet-protocol based all-in-one call center solution that uses software executing on a single network for both data and voice communication.

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning-” in the claims section.

Discussion of the Figures

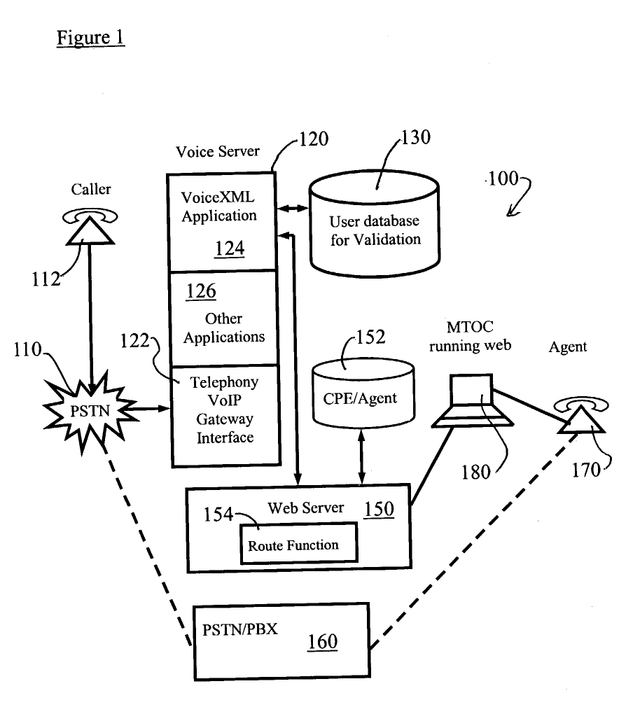

Features and advantages of the invention can be better understood by reviewing FIG. 1, which shows one embodiment of a web-enabled computer telephony system (the system) 100. Generally, the system provides a call center (such as a customer relations management (CRM) center) solution via a single network that includes a voice server 120, and an internet-enabled web server (the web server) 150 that performs computer telephony integration (CTI) server operations, and automatic call distributor (ACD) operations. Preferably, the system achieves functionality by utilizing Voice over Internet Protocol.

In a preferred embodiment, the system 100 interfaces with a Public Switched Telephone Network (PSTN) 110, which may be broadly defined as including a caller 112, through a telephony interface 122 that is maintained in the voice server 120. This interface allows, among other advantages, the system 100 to accept calls from the general public. The voice server 120 is generally any computing platform that executes software that enables voice data recognition. In a preferred embodiment, the voice data recognition software is a W3C standard voice application such as a VoiceXML Application 124.

Of course, the voice server 120 may maintain other software modules that are used within the system 100, or that run independent of the system 100. The VoiceXML Application 124 in the Voice Server 120 communicates with a User Database 130 that may be either local or remote to the Voice Server 120, and is typically used to validate caller data (caller identification, passwords, or specific data information, for example).

The web server 150 is any computer server enabled to perform computer telephony integration (CTI) server operations and automatic call distributor (ACD) operations (exemplary methods of using the web server 150 are discussed in greater detail below). In a preferred embodiment, the web server 150 accesses a database 152 comprising agent information, agent database information, or customer premises information (CPI), for example. CPI may include customer service agents, an associated terminal, a manual terminal operator consol (MTOC), and/or location information, for example. The database 152 may be either remote from or local to the web server 150.

The preferred embodiment of the system 100 routes voice and data, as described below, to an agent terminal through a web server via the use of VoIP. VoIP may also be used to transfer voice and data between the Voice Server 120 and the web server 150. Of course, although the invention is described as having a single agent 170 and a single agent terminal 180, it is understood that in practice many agents and agent terminals are in communication with the system 100. However it should be understood that the telephony interface 122 may route incoming calls directly to a Public Switched Telephone Network (PSTN)/Private Branch Exchange (PBX) 160 standard telephone system. The PBX 160 then routes calls directly to an agent 170 who is identified by the system 100 as either the independent recipient of a call, or the agent 170 corresponding to an agent terminal 180.

Accordingly, a caller 112 calls into the system via the PSTN 100. The call is answered by the Voice Server 120 that preferably utilizes VoiceXML. The call is also routed to an agent 170 who may be in a call center or located remotely (such as at home), and to the Web Server 150 with Voice over Internet Protocol (VoIP). The Web Server is enabled to provide both ACD and CTI services to that data associated with the call can “pop” up on the agent's terminal 180, which is preferably running an internet browser.

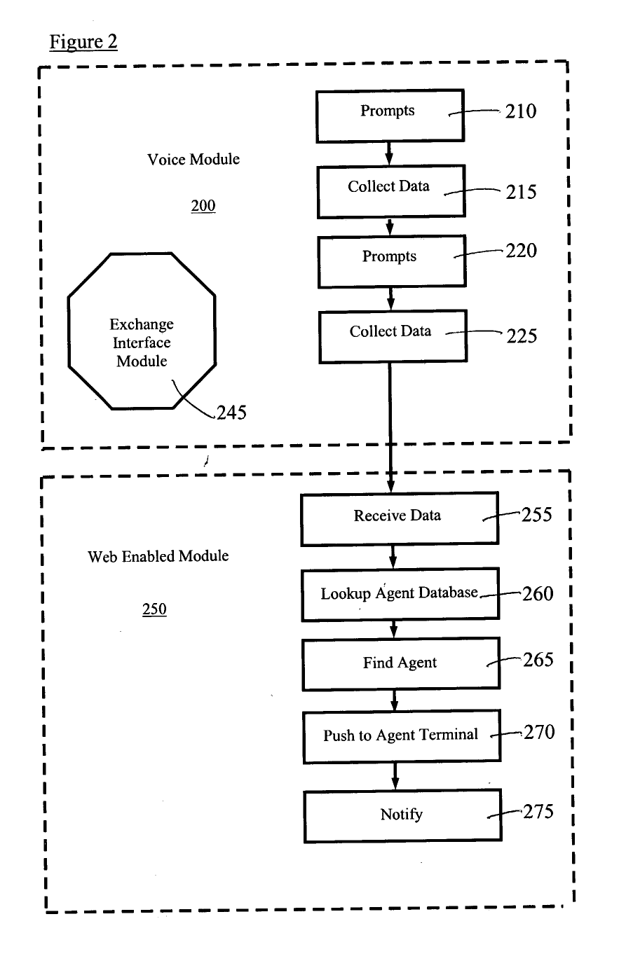

FIG. 2 illustrates one method of operation of a computer telephony system based on a web server telephony server. In general, the method implements a call center solution to carry a message to a customer service center by implementing a voice server module 200 and a web server module 250. The voice server module 200 comprises software that generally executes on a voice server, and the web server module 250 generally includes software that executes on a web enabled server, as discussed above.

However, it should be understood that the invention may be defined without a clear functional boundary between the voice module 200 and the web server module 250 as it is readily apparent to those of ordinary skill in the art that certain functions of either module may be relocated to the other module. Accordingly, in these circumstances, the decision of the location of the specific code dedicated to a specific operation is an engineering decision, and within the scope of the invention.

In a one embodiment, the voice server module 200 prompts a user for input in a prompt for data act 210, and collects user input speech data in a collect data act 215. Preferably, the voice server module 200 collects user input speech data by using voice recognition technology that is integrated with the voice server module. Next, the user input speech data is validated in a validate act 220. In one embodiment, the validation is made via an external customer database. Next, the voice server module 210 sends the user input speech data to the web module 250 in a export act 225, which may transfer both speech data and calling party information to the web server module 250.

Next, the web server module (or, web enabled module) 250 receives the data from the voice module 210 in a receive data act 255. Next, in a lookup act 260, the web server module 250 performs a database lookup with an agent database to find the appropriate agent (who may be stationed by a manual terminal operator module (MTOC)). The agent will preferably be associated with a terminal that runs a browser corresponding to an appropriate agent.

In a find agent act 265, the module 250 locates the agent terminal associated with a particular agent, or a particular agent profile based on skill sets such as language, technical specialty, or skill level, for example. Then, in a push act 270, the web server module 250 pushes the received data to a means for viewing the web browser, such as an applet, so that the data can be viewed on a web browser running on an agent terminal. The web server module 250 notifies the agent that data is available with a flag or other means in a notify act 275.

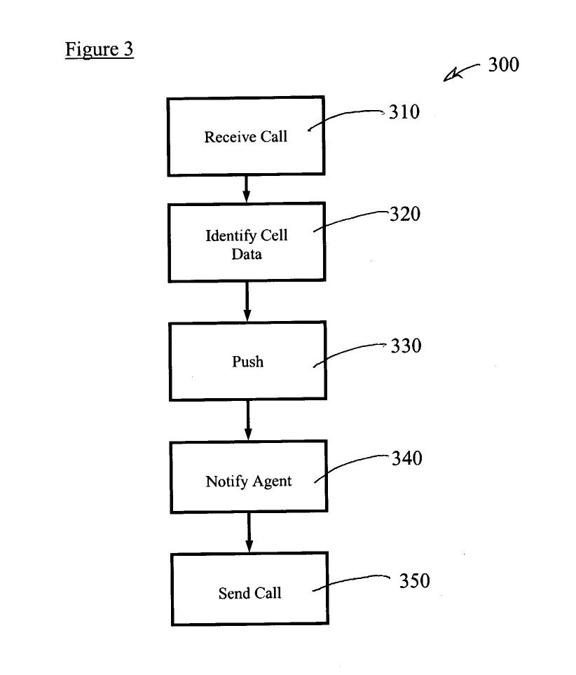

FIG. 3 teaches one method of operation of a web server/telephony server in a computer telephony system as an advanced telephony algorithm (the algorithm) 300. The algorithm 300 implements a call center solution to carry a message to a customer service center via a standard server(s). Generally, the algorithm 300 receives a phone call in a receive call act 310. Next, call data is identified in an identify call data act 320. Next, in a push act 330, the call data is pushed to a web-browser in a web-browser viewable format. Then, in a notify agent act 340, an agent is notified that the call data is viewable, and in a send call act 350 the call is sent to the agent previously notified.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A system that provides a call center solution, comprising:
a single network comprising:
a voice server; and
an internet-enabled web server (the web server) that performs computer telephony integration (CTI) server operations and automatic call distributor (ACD) operations.

2. The system of claim 1 wherein the web server accesses a database comprising call center agent information.

3. The system of claim 2 wherein the database includes at least one of: a listing of customer service agents, an associated terminal, or a location information.

4. The system of claim 1 wherein the voice server comprises a W3C standard voice application.

5. The system of claim 4 wherein the W3C standard voice application is an XML application.

6. The system of claim 1 wherein the web server accesses a database comprising agent information.

7. A method of implementing a call center solution to carry a message to a customer service center, comprising:
a voice server module; and
a web server module.

8. The method of claim 7 wherein the voice server module collects user input speech data.

9. The method of claim 7 wherein the voice server module collects user input speech data by using voice recognition technology that is integrated with the voice server module.

10. The method of claim 8 further comprising validating the user input speech data.

11. The method of claim 10 further comprising extracting user data, and sending the user data to the web module for facilitating customer interaction.

12. The method of claim 7 wherein the voice module further comprises an exchange interface module.

13. The method of claim 7 wherein the voice module further comprises transferring both speech data and calling party information to the web server module.

14. The method of claim 7 further comprising carrying the message to an agent terminal.

15. The method of claim 8 wherein the web server module receives the data from the voice module.

16. The method of claim 15 wherein the web server module performs a database lookup to find the appropriate agent terminal.

17. The method of claim 16 wherein the web server module pushes the received data to a means for viewing the web browser.

18. The method of claim 17 wherein the web server module notifies the appropriate agent.

19. A system that implements a call center solution to carry a message to a customer service center in a single server, comprising:
receiving a phone call;
identifying a call data;
pushing the call data to a web-browser viewable format; and
notifying an agent that the call data is viewable.
